(19) United States
(12) Patent Application Publication
(10) Pub. No.: US 2008/0316659 A1
(43) Pub. Date: Dec. 25, 2008

(54) HIGH VOLTAGE ESD PROTECTION FEATURING PNP BIPOLAR JUNCTION TRANSISTOR

(76) Inventors: Ismail Hakki Oguzman, Plano, TX (US); John Eric Kunz, JR., Allen, TX (US)

Correspondence Address: TEXAS INSTRUMENTS INCORPORATED, P O BOX 655474, M/S 3999, DALLAS, TX, 75265, US

(21) Appl. No.: 11/765,109

(22) Filed: Jun. 19, 2007

(51) Int. Cl. H02H 9/04; H02H 9/00

(52) U.S. Cl. 361/56; 361/111

(57) ABSTRACT

A protection circuit is disclosed that protects a semiconductor device from damage due to an electrostatic discharge. One such protection circuit comprises a vertical pnp hetero-junction bipolar transistor (HBT) connected between terminals such as supply terminals of the device, configured to conduct during an electrostatic discharge. The protection circuit also comprises a trigger circuit, such as a transient activated RC circuit connected between the terminals to detect the electrostatic discharge and control the transistor based on the detected electrostatic discharge. A Darlington transistor pair in the trigger circuit can be used to multiply the effective capacitance and HBT drive current. The HBT transistor absorbs energy from the electrostatic discharge and clamps the over-voltage across the terminals. The protection circuit may also be used across other I/O terminals of the device.

### FIELD OF THE INVENTION

The present invention relates generally to semiconductor device fabrication, and more particularly, to an improved high voltage electrostatic discharge (ESD) protection circuit implemented as a transient activated, hetero-junction bipolar transistor (HBT) having reduced device area, a higher holding voltage, and reduced leakage current.

### BACKGROUND OF THE INVENTION

A variety of electronic devices are sensitive to electrostatic discharge (ESD), whether the device is powered up and active, remains without power, or during handling of the device prior to assembly.

The npn bipolar junction transistor (BJT), which is typically the device of choice for protection against ESD in BJT process technologies, suffers from low holding voltages (defined as the voltage at which a device goes into and remains in a low-impedance, conducting state; typically 5-10 V in an npn BJT) compared to the maximum operating voltage in high-voltage (typically larger than 10 V) integrated circuit (IC) applications. This characteristic renders npn BJT-based ESD protection approaches undesirable, as this low holding voltage creates a potential risk of latch-up. That is, the device may remain in a conducting or shorted state under powered-up normal operating conditions, which can result in a device malfunction and/or the destruction of the ESD protection circuit. Consequently, ESD protection schemes, where the primary device is an npn bipolar transistor, may not be suitable for the protection of power supply pins, or for any pin sinking large DC currents (typically greater than about 10 mA).

In a conventional homo-junction bipolar process technology, the main drawback of using a pnp transistor for ESD protection, as opposed to an npn transistor, is the relatively low current gain of the pnp device which hampers the ESD current dissipation capability.

Several prior art high voltage ESD protection approaches have been used, but may require a large chip area. This large area is generally needed because of the numerous lower voltage components required to create a high voltage trigger reference and also because of the spacing requirements between the many components.

Accordingly, it would be desirable to have a high voltage ESD protection circuit for a semiconductor device that has a reduced device area and leakage current yet maintains a high holding voltage to mitigate the risk of latch-up.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

The present invention comprises a high voltage electrostatic discharge (ESD) protection circuit for a semiconductor device implemented in a PNP hetero-junction bipolar transistor (HBT) having a higher holding voltage that reduces the potential of latch-up, and a transient-activated trigger circuit that has reduced leakage current while requiring less device area. In one embodiment, the electrostatic discharges can be shunted or otherwise limited in amplitude by conducting a current through the high voltage capable HBT of the ESD protection circuit during an ESD event detected by a capacitive transient trigger circuit. The high voltage and high current HBT is configured to absorb the energy of an over-voltage from the ESD event.

According to one or more aspects of the present invention, the electrostatic discharge protection circuit comprises a first pnp hetero-junction bipolar transistor (HBT) connected between terminals of a semiconductor device, and configured to conduct during an electrostatic discharge. The protection circuit also includes a trigger circuit connected between the terminals and configured to detect the electrostatic discharge and control the pnp HBT based on the detected electrostatic discharge. The transistor absorbs energy from the electrostatic discharge to clamp a voltage (e.g., an ESD over-voltage) across the terminals.

In a further aspect of the invention, the protection circuit also comprises a second high voltage pnp transistor connected between the terminals of the semiconductor device, the second transistor configured as a diode to conduct during a negative over-voltage associated with the electrostatic discharge, wherein the second transistor absorbs energy from the electrostatic discharge by diode clamping the negative over-voltage across the terminals.

In another aspect of the invention, the trigger circuit comprises a transient activated resistor-capacitor (RC) circuit comprising one or more resistors and a capacitor that are series connected, the RC circuit is configured to detect a positive over-voltage associated with the electrostatic discharge by producing a voltage drop across the resistor and the control terminal of the first transistor, and causing the first transistor to conduct during the over-voltage based on the detected electrostatic discharge.

In yet another aspect, the trigger circuit may also include a Darlington configuration transistor circuit configured to multiply the current available from the resistor-capacitor circuit to control the first transistor based on the detected electrostatic discharge. The Darlington transistors may also comprise the high voltage HBT transistors or another high voltage transistor.

In one embodiment of the invention, the first pnp hetero-junction bipolar transistor has dissimilar emitter and base materials, wherein if the base comprises silicon-germanium (Si—Ge), the emitter comprises silicon (Si); and if the base comprises gallium arsenide (GaAs), the emitter comprises aluminum gallium arsenide (AlGaAs), for example, wherein a sufficiently high holding voltage is provided to the transistor such that latch-up is avoided.

In another aspect, the HBT transistor is operable at about 36-40 volts or up to about the collector-emitter breakdown voltage when the base is open, and at a holding voltage which avoids latch-up during powered-up normal operating conditions.

In another embodiment, the first pnp hetero-junction bipolar transistor comprises an n-type silicon-germanium epitaxial layer in a base region of the transistor and comprises a vertical hetero-junction bipolar transistor configuration.

In another aspect, the first pnp hetero-junction bipolar transistor further comprises a p-type emitter polysilicon material layer in the emitter region of the transistor overlying the n-type silicon-germanium epitaxial base layer in the base region of the transistor.

In yet another embodiment of the present invention, an electrostatic discharge protection circuit, comprises a first pnp hetero-junction bipolar transistor connected between power supply terminals of a semiconductor device, the first transistor configured to conduct during a positive over-voltage associated with an electrostatic discharge. The protection circuit also includes a trigger circuit connected between the power supply terminals and configured to detect the electrostatic discharge and control the first transistor at a control terminal thereof based on the detected electrostatic discharge, wherein the first transistor absorbs energy from the electrostatic discharge by clamping the positive over-voltage detected across the power supply terminals.

In yet another embodiment of the present invention, an electrostatic discharge protection circuit, comprises an energy absorbing means for dissipating an over-voltage between two terminals of a semiconductor device during an electrostatic discharge, switching means for switching between the energy absorbing means and one of the two terminals for conducting energy of the over-voltage into the energy absorbing means for limiting the over-voltage during the electrostatic discharge, triggering means for detecting the electrostatic discharge between the terminals, and controlling means for controlling the switching means to conduct the energy of the over-voltage into the energy absorbing means based on the detected electrostatic discharge, thereby limiting an amplitude of the electrostatic discharge.

Thus a high voltage ESD protection circuit is disclosed for protecting a semiconductor device, having a reduced device area and leakage current while maintaining a high holding voltage to mitigate the risk of latch-up.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of only a few of the various ways in which the principles of the invention may be employed. Other objects, advantages, and novel features of the invention will become apparent from the following detailed description of the invention when considered in conjunction with the drawings.

### BRIEF DESCRIPTION OF THE DRAWINGS

FIG. 1A is a schematic diagram of a prior art npn DC activated electrostatic discharge protection circuit such as may be used in a semiconductor device.

FIG. 1B is a simplified cross-sectional view of a conventional vertical npn bipolar homo-junction transistor (BJT) employing an emitter (E), a base (B), and a collector (C) formed in a p-type semiconductor substrate.

FIG. 2A is a simplified schematic diagram of an exemplary electrostatic discharge protection circuit employing a high voltage pnp hetero-junction bipolar transistor (HBT) and a trigger circuit such as may be used in accordance with the present invention to protect an exemplary semiconductor device.

FIG. 2B is a schematic diagram of one exemplary pnp electrostatic discharge protection circuit employing a high voltage pnp hetero-junction bipolar transistor (HBT) and a transient-activated trigger circuit such as may be used in accordance with the present invention to protect an exemplary semiconductor device.

FIG. 2C is a simplified schematic diagram of another exemplary electrostatic discharge protection circuit employing a high voltage pnp hetero-junction bipolar transistor (HBT) and a trigger circuit having a current multiplier or a capacitive multiplier configuration such as may be used in accordance with the present invention to protect an exemplary semiconductor device.

FIG. 2D is a schematic diagram of one exemplary electrostatic discharge protection circuit employing a high voltage pnp hetero-junction bipolar transistor (HBT) and a DC voltage-activated trigger circuit such as may be used in accordance with the present invention to protect an exemplary semiconductor device.

FIGS. 3A and 3B are cross-sectional views of high voltage npn and pnp hetero-junction bipolar transistors (HBTs), respectively, such as may be used in the exemplary pnp electrostatic discharge protection circuits of FIGS. 2A-2D in accordance with one or more aspects of the present invention, the HBTs employing a Si—Ge base (B) region, wherein the emitter and base regions employ dissimilar materials to obtain high voltage and high current operation.

### DETAILED DESCRIPTION OF THE INVENTION

The present invention will now be described with respect to the accompanying drawings in which like numbered elements represent like parts. The figures provided here and the accompanying description of the figures are merely provided for illustrative purposes. One of ordinary skill in the art should realize, based on the instant description, other implementations and methods for fabricating the devices and structures illustrated in the figures and in the following description.

In the present invention, the primary device used for ESD protection is a pnp transistor. Holding voltage, the main device characteristic prohibiting the use of an npn transistor for ESD protection, can be considerably higher in a pnp transistor, and may actually exceed the maximum operating voltage of the device pin (terminal) to be protected. In that case, the pnp transistor could be used for ESD protection.

In a conventional homo-junction bipolar transistor (HBT) technology, the main drawback of using a pnp transistor for ESD protection, as opposed to an npn transistor, is the relatively low current gain of the pnp device which hampers the ESD current dissipation.

The current invention uses a hetero-junction bipolar technology, where not only the npn transistor, but also the pnp transistor features a SiGe base region. Consequently, the pnp transistor has practically the same current gain as the npn transistor, for example, about 200 at high currents, which would be most relevant to the conditions of ESD current conduction.

It should be noted that even within the HBT technology, the inventors of the present invention obtained a surprising result. In particular, although an npn type HBT was attempted in the development of the ESD protection circuit, the npn type HBT only achieved a holding voltage of about 5 volts, while a subsequent attempt of a pnp type HBT achieved a dramatically improved holding voltage of about 45 volts together with a similar current gain result. This was a beneficially surprising result given the HBT technology, and the conventional wisdom that npn type transistors generally provide a much higher current gain than pnp transistors. These principles will become more apparent in light of the following figures.

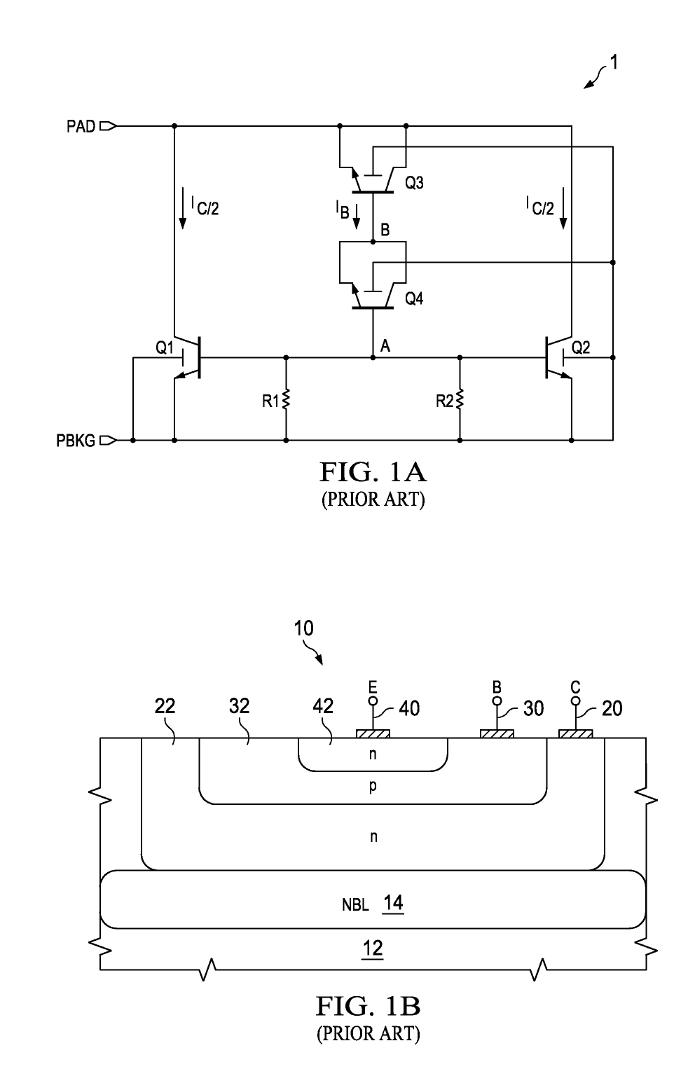

Turning to FIG. 1 for example, a conventional npn direct current (DC) activated electrostatic discharge protection circuit 1 is illustrated such as may be used to protect pins of a semiconductor device. ESD protection circuit 1 is connected between PAD and PBKG pins or terminals of the device and therefore protects these terminals from an ESD event. Protection circuit 1 comprises a pair of conventional npn homo-junction bipolar transistors (BJTs) Q1 and Q2, which both conduct during a positive-going over-voltage ESD event as directed by zener connected transistor structures Q3 and Q4.

In the prior art protection circuit 1, two 4.5 volt zeners Q3 and Q4 are wired in series to attain a desired 9 volt zener voltage between PAD and node A, which when biased by emitter-base bias resistors R1 and R2, causes conventional BJT transistors Q1 and Q2 to each conduct a collector current of I_{c}/2 at about 9.7-10 volts at PAD with respect to PBKG. Thus, depending on the current gain of the transistors Q1 and Q2 as well as the energy of the ESD event, an ESD induced over-voltage exceeding 10 volts between the PAD and PBKG pins will be shunted or limited starting from just above 10 volts.

It will be appreciated from FIG. 1A, that to attain operation at much higher voltages, for example, on the order of about 40 volts, a stack of about 8 such zeners using the conventional homo-junction bipolar transistor configuration would be needed. Accordingly, it can also be appreciated that such a large stack would require a very large chip area for the 8 zeners as well as to accommodate the necessary separation between all these zeners for the higher voltage.

In addition to the large area requirement of numerous zener diodes, the use of a zener has a significant drawback of not achieving a low DC leakage current in the biasing of the zener.

FIG. 1B illustrates a conventional vertical npn bipolar homo-junction transistor (BJT) 10, such as the conventional BJT transistors used in the protection circuit 1 of FIG. 1A. BJT transistor 10 is formed in a p-type semiconductor substrate 12, and comprises a collector (C) 20, a base (B) 30, and an emitter (E) 40. A highly doped n-type buried layer NBL 14 is formed in the p-type semiconductor substrate 12, the collector C 20 is formed in an n-well 22 overlying the n-type buried layer NBL 14, the base B 30 is formed in a p-well 32 overlying the collector n-well 22, and the emitter E 40 is formed in an n-type region 42 overlying the base p-well 32.

Although the conventional BJT transistor has a simple process that is compatible with a standard CMOS flow, this technology also has a low current handling capability and low holding voltage which increases the susceptibility of a protection circuit to latch-up during powered-up normal operating conditions. This low holding voltage problem is particularly evident at the much higher voltages anticipated for the protection circuit used in the present invention.

Accordingly, the present invention provides a relatively small (e.g., the trigger circuit is about ⅓^{rd} the area of a conventional trigger circuit) protection circuit that can be operated at high voltages (e.g., about 40 volts), with a high holding voltage (e.g., >45 volts) and a high current gain (e.g., about 200), employing hetero-junction bipolar technology.

In particular, the present invention provides an electrostatic discharge protection circuit comprising a hetero-junction bipolar transistor (HBT) connected between terminals of a semiconductor device which is to be protected, wherein the HBT is configured to conduct during an electrostatic discharge ESD. The protection circuit further comprises a trigger circuit connected between the terminals and is configured to detect the ESD and control the HBT based on the detected ESD. During an ESD, the HBT conducts and absorbs energy from the ESD to clamp a voltage across the terminals, thereby protecting the semiconductor device. Beneficially, the pnp type HBT has a high holding voltage for avoiding latch-up conditions, and a high current capability which is well suited for the ESD protection circuits of the present invention. In addition, by employing a current multiplying or capacitive multiplying circuit in a transient activated trigger circuit, for example, the device real-estate required separating a large number of zener or other reference devices in the trigger circuit may be greatly reduced, for example, to about ⅓^{rd} of chip area of a conventional trigger circuit. These and other aspects of the invention will become more apparent in light of the figures and accompanying descriptions.

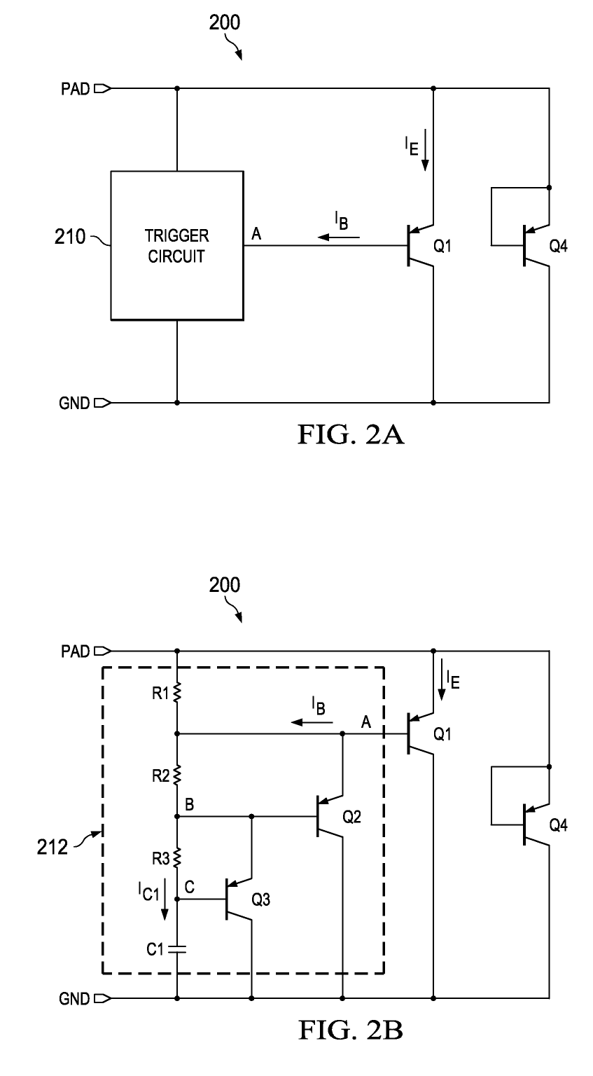

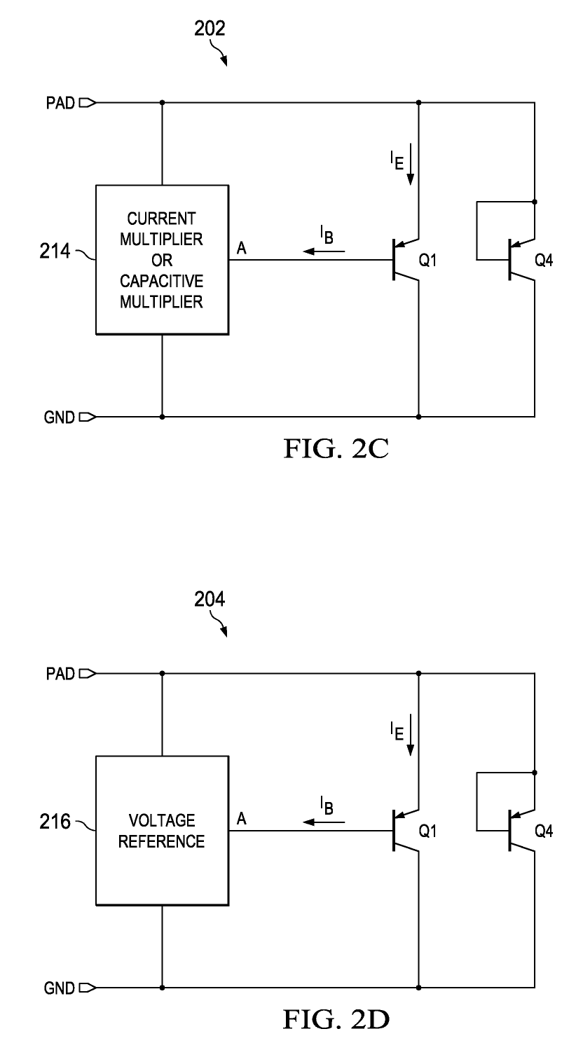

For example, FIGS. 2A-2D illustrate exemplary ESD protection circuits that employ a high voltage pnp hetero-junction bipolar transistor HBT (Q1) and several configurations of a trigger circuit, such as may be used in accordance with the present invention to protect an exemplary semiconductor device.

FIG. 2A illustrates an exemplary electrostatic discharge protection circuit 200 employing a high voltage pnp HBT Q1 such as may be used in accordance with the present invention to protect an exemplary semiconductor device. HBT Q1 comprises a high holding voltage, high current transistor connected between PAD and GND device terminals or pins. The protection circuit 200 further comprises a trigger circuit 210, such as a transient activated circuit such as a resistor-capacitor (RC) circuit, or a zener based DC activated circuit, for example. Although a large area would likely be required, in another exemplary embodiment of the transient activated circuit, a single resistor and a large capacitor may be utilized within the trigger circuit 210.

During an ESD event, Q1 conducts an emitter current I_{E} as controlled by trigger circuit 210 at a control node A (e.g., base terminal of Q1) in response to a base current I_{B}. As Q1 conducts, energy of an over-voltage from the ESD is shunted and absorbed by Q1 to limit a voltage across the PAD and GND device terminals.

Protection circuit 200 further comprises a high voltage diode Q4, such as a second high voltage transistor or a second pnp HBT, configured as a diode and connected between the terminals of the semiconductor device to conduct during a negative over-voltage associated with the electrostatic discharge. Q4 absorbs energy from the ESD by diode clamping the negative over-voltage across the terminals.

FIG. 2B illustrates one exemplary embodiment of the electrostatic discharge protection circuit 200 of FIG. 1, employing a high voltage pnp hetero-junction bipolar transistor HBT Q1 such as may be used in accordance with the present invention to protect an exemplary semiconductor device. HBT Q1 again comprises a high holding voltage, high current transistor connected between PAD and GND device terminals or pins. The protection circuit 200 further comprises a capacitance based transient activated trigger circuit 212.

Trigger circuit 212 includes a resistor-capacitor or RC circuit comprising resistors R1, R2, and R3 series connected to capacitor C1. Resistors R1, R2, and R3 also serve as emitter-base bias resistors for Q1, Q2, and Q3, respectively. Trigger circuit 212 also includes a Darlington configuration of transistors Q2 and Q3, which multiplies the current available to drive Q1 at control node A of Q1. The Darlington configuration of transistors Q2 and Q3 also multiplies the effective capacitance of C1 available to drive the base current I_{B} at control node A of Q1. Accordingly, the size of C1 may be proportionately reduced in size by the current gain increase provided by utilizing the Darlington transistors Q2 and Q3, and such C1 size decrease also decreases the trigger circuit chip area required.

The capacitor based transient trigger circuit of the present embodiment also has the significant advantage of achieving a low DC leakage current, as the bias current on the capacitor C1 will quickly drop to substantially zero when charged to the voltage applied to the PAD terminal.

Although a larger area would be required, in another exemplary embodiment of the transient activated circuit, a single resistor and a large capacitor may be utilized within the trigger circuit 210 of FIG. 2A or trigger circuit 212 of FIG. 2B.

FIG. 2C illustrates another exemplary embodiment of an ESD protection circuit 202 similar to the electrostatic discharge protection circuit 200 of FIG. 1, employing a high voltage pnp hetero-junction bipolar transistor HBT Q1 such as may be used in accordance with the present invention to protect an exemplary semiconductor device. Protection circuit 200 of FIG. 2C comprises a trigger circuit 214 having a current multiplier or a capacitive multiplier configuration such as may be used in accordance with the present invention to protect an exemplary semiconductor device. For example, the trigger circuit 214 may comprise another variation of the RC circuit and another variation of the Darlington transistor circuit of FIG. 2B, another current multiplier configuration, or another capacitive multiplier configuration. For example, a minimal size RC circuit may be combined with an amplifier circuit.

FIG. 2D illustrates yet another exemplary embodiment of an ESD protection circuit 204 similar to the electrostatic discharge protection circuit 200 of FIG. 2A employing a high voltage pnp HBT such as may be used in accordance with the present invention to protect an exemplary semiconductor device. Protection circuit 204 comprises a DC voltage-activated trigger circuit based on a fixed voltage reference, a resistor and zener circuit, a 3-terminal voltage regulator, a current reference based circuit, or a current mirror circuit, for example.

Although the protection circuits 200, 202, and 204 illustrate the use of a second high voltage transistor or a second pnp HBT configured as a diode, or another such high voltage diode Q4, it will be appreciated that in the context of the present invention that such a high voltage diode Q4 need not be included in the protection circuits to limit a negative over-voltage of the ESD, particularly if a negative over-voltage is not anticipated, or is otherwise limited by other circuitry. Alternately, a negative over-voltage of an ESD may be addressed by a similar second protection circuit (without Q4) connected in an inverted configuration to the opposite PAD and GND terminals.

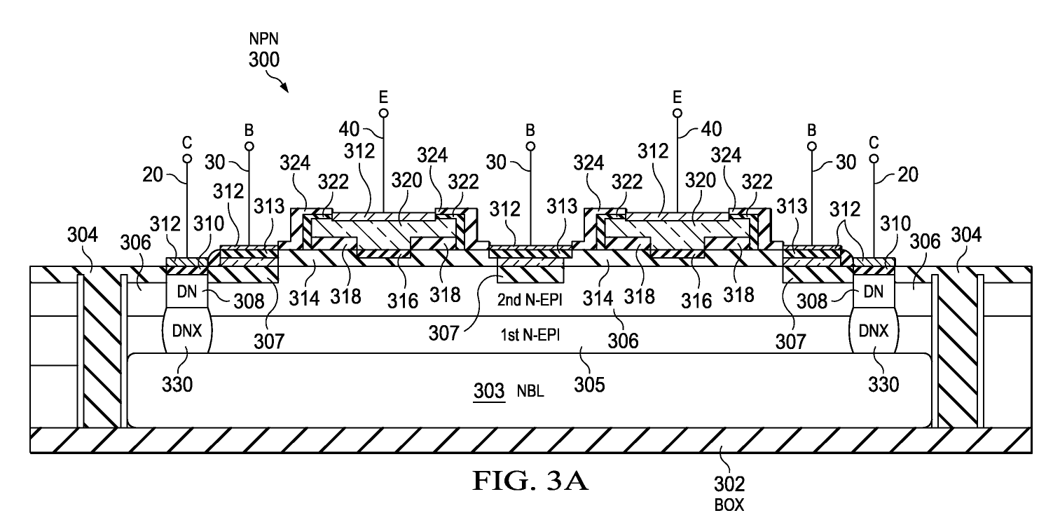

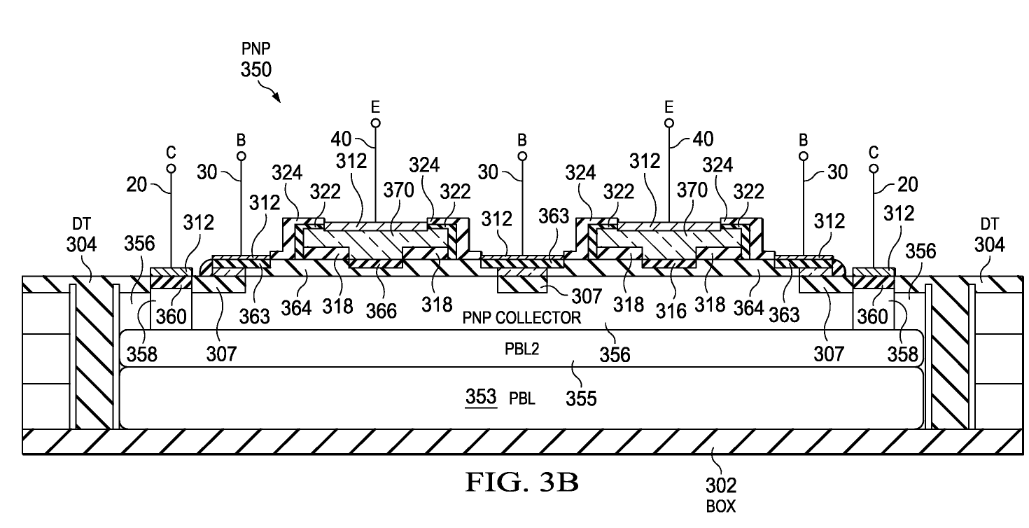

FIGS. 3A and 3B illustrate one embodiment of an npn 300 and a pnp 350 hetero-junction bipolar transistor (HBT), respectively, such as may be used in the exemplary pnp electrostatic discharge protection circuits of FIGS. 2A-2D in accordance with one or more aspects of the present invention. Both the npn HBT 300 and the pnp HBT 350 utilized in the present invention employ a Si—Ge base (B) region B 30, wherein the emitter E 40 and base regions B 30 employ dissimilar materials. The structural configuration of the HBT devices employed in accordance with the present invention comprises a vertical HBT configuration, because the current path thru the vertical HBT device between the collector C 20 and the emitter E 40 generally follows a vertical path.

As previously indicated, although the npn HBT 300 achieves a somewhat conventional holding voltage of about 5 volts, the pnp HBT 350 obtains a surprising result by achieving a substantially higher holding voltage of about 45 volts and a high current capability which enables high voltage and high current operation for the ESD protection circuits illustrated and described herein. However, the hetero-junction bipolar technology utilized herein provides both npn and pnp transistors within the same structure that may typically have a higher current gain and higher current handling capability than conventional homo-junction transistors. These performance capabilities of the pnp HBT 350 provide ideal ESD protection conditions for a semiconductor device for protecting power supply and/or input-output (I/O) pins or terminals of the device.

It will be appreciated that, when protecting I/O pins of a device from fast transient signals, extra circuits or another disabling means may be added to the present invention to prevent it from turning on as a result of the fast transient. A DC activated, zener or reference voltage based trigger circuit, however, would generally not need the disabling means when used to protect I/O pins of a device, as the ESD/fast transient would only be limited above the fixed zener or reference voltage.

FIG. 3A, for example, illustrates the npn hetero-junction bipolar transistor HBT 300, comprising an underlying buried oxide layer Box 302, an n-type buried layer NBL 303 formed overlying the Box 302, an overlying 1^{st} n-type epitaxial layer 1^{st} n-epi 305, and a 2^{nd} n-type epitaxial layer 2^{nd} n-epi 306 formed overlying the 1^{st n}-epi 305. NPN HBT 300 further comprises shallow trench isolation regions STI 307 formed within the 2^{nd} n-epi 306 to isolate and define overlying base B 30 regions, comprising a p-type silicon-germanium epitaxial base layer (p-type SiGe epi base layer) 314. Deep n-wells 308 and deep n-well extensions 330 are also formed in collector C 20 regions, within the 2^{nd} n-epi 306 and within the 1^{st} n-epi 305 layers, respectively, which are then overlaid with an n+ diffusion layer 310 and a conductive CoSi layer 312 for electrical connection of one or more collector contacts to a collector terminal C 20.

Portions of the p-type SiGe epi base layer 314 are overlaid with a p-type diffusion layer 313 and the conductive CoSi layer 312 for electrical connection of a base terminal B 30. Overlying the p-type SiGe epi base layer 314, a second n-type diffusion layer 316, an overlying nitride 318, and an overlying n-type emitter poly NEMIT 320 are formed within one or more emitter E regions 40. Oxide offset spacer layers OS 322 and nitride side-wall spacer layers SWS 324 are formed generally on lateral sidewalls of the emitter E regions 40. The conductive CoSi layer 312 is also formed overlying the n-type emitter poly NEMIT 320 for electrical connection of an emitter terminal E 40 within the one or more emitter E regions 40. Thereafter, in the formation of inter-metal dielectric layers (not shown) multiple collector C 20, base B 30, and emitter E 40 contacts may be interconnected between respective contacts to form single collector C 20, base B 30, and emitter E 40 terminals of the npn HBT 300. Deep trench oxide regions DT 304 may be used to isolate and/or separate the npn HBT 300 from other structures.

FIG. 3B illustrates an exemplary higher holding voltage pnp hetero-junction bipolar transistor HBT 350, comprising an underlying buried oxide layer Box 302, a 1st p-type buried layer PBL 353 formed overlying the Box 302, an overlying 2^{nd} p-type buried layer PBL2 355, and a p-type epitaxial collector layer PNP collector 356 formed overlying the PBL2 355. PNP HBT 350 further comprises shallow trench isolation regions STI 307 formed within the PNP collector 356 to isolate and define overlying base B 30 regions, comprising an n-type silicon-germanium epitaxial base layer (n-type SiGe epi base layer) 364. Deep p-wells 358 are also formed in collector C 20 regions, within the PNP collector 356 layer, and overlaid with a p-type diffusion layer 360 and a conductive CoSi layer 312 for electrical connection of one or more collector contacts to a collector terminal C 20.

Portions of the n-type SiGe epi base layer 364 are overlaid with an n-type diffusion layer 363 and the conductive CoSi layer 312 for electrical connection of a base terminal B 30. Overlying the n-type SiGe epi base layer 364, a second p-type diffusion layer 366, an overlying nitride 318, and an overlying p-type emitter poly PEMIT 370 are formed within one or more emitter E regions 40. Oxide offset spacer layers OS 322 and nitride side-wall spacer layers SWS 324 are formed generally on lateral sidewalls of the emitter E regions 40. The conductive CoSi layer 312 is also formed overlying the p-type emitter poly PEMIT 370 for electrical connection of an emitter terminal E 40 within the one or more emitter E regions 40. Thereafter, in the formation of inter-metal dielectric layers (not shown) multiple collector C 20, base B 30, and emitter E 40 contacts may be interconnected between respective contacts to form single collector C 20, base B 30, and emitter E 40 terminals of the pnp HBT 350. Deep trench oxide regions DT 304 may be used to isolate and/or separate the pnp HBT 350 from other structures.

The inventors of the present invention have further appreciated that the pnp HBT 350 employed in the protection circuits of the present invention may be used to provide a robust solution for the ESD protection of high-voltage pins in bipolar and/or BiCMOS technologies, or other such technologies utilizing vertical hetero-junction bipolar transistors, where both npn and pnp transistors may be required in a semiconductor device, for example.

Although the invention has been shown and described with respect to a certain aspect or various aspects, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several aspects of the invention, such feature may be combined with one or more other features of the other aspects as may be desired and advantageous for any given or particular application. Furthermore, to the extent that the term “includes”0 is used in either the detailed description or the claims, such term is intended to be inclusive in a manner similar to the term “comprising.”

What is claimed is:

1. An electrostatic discharge protection circuit, comprising:
a first pnp hetero-junction bipolar transistor connected between terminals of a semiconductor device, and configured to conduct during an electrostatic discharge; and
a trigger circuit connected between the terminals and configured to detect the electrostatic discharge and control the pnp hetero-junction bipolar transistor based on the detected electrostatic discharge;
wherein the transistor absorbs energy from the electrostatic discharge to clamp a voltage across the terminals.

2. The protection circuit of claim 1, wherein the trigger circuit comprises a transient activated resistor-capacitor (RC) circuit comprising a resistor and a capacitor that are series connected, the RC circuit configured to detect a positive over-voltage associated with the electrostatic discharge by producing a voltage drop across the resistor and the control terminal of the first transistor, and causing the first transistor to conduct during the over-voltage based on the detected electrostatic discharge.

3. The protection circuit of claim 2, wherein the trigger circuit further comprises a Darlington transistor circuit configured to multiply the current available from the resistor-capacitor circuit to control the first transistor to conduct or turn off based on the detected electrostatic discharge.

4. The protection circuit of claim 3, wherein the Darlington transistor circuit comprises Darlington connected pnp hetero-junction bipolar transistors individually comprising a resistor connected between emitter and base terminals of the Darlington connected transistors, and wherein an output of the Darlington connected transistors is connected to the control terminal of the first transistor, and an input of the Darlington connected transistors is connected to a capacitor of the transient activated resistor-capacitor (RC) circuit.

5. The protection circuit of claim 2, wherein the trigger circuit further comprises a capacitive multiplier circuit configured to multiply the capacitance of the resistor-capacitor circuit to provide a larger current for controlling the first transistor based on the detected electrostatic discharge.

6. The protection circuit of claim 4, wherein the detected electrostatic discharge comprises an increased current through the trigger circuit associated with the electrostatic discharge, which forward biases the Darlington connected transistors to conduct and drive the first transistor into conduction to limit an over-voltage resulting from the electrostatic discharge.

7. The protection circuit of claim 4, wherein the detected electrostatic discharge comprises one of a voltage surge at a supply terminal, a voltage increase to an input or output terminal of the semiconductor device, and a current increase to the trigger circuit.

8. The protection circuit of claim 1, wherein the trigger circuit comprises a DC voltage activated zener circuit comprising a resistor and a zener connected in series, configured to detect a current increase to a zener diode from the control terminal of the first transistor, by producing a voltage drop across the resistor and the control terminal of the first transistor, and causing the first transistor to conduct during the over-voltage based on the detected electrostatic discharge.

9. The protection circuit of claim 8, wherein the trigger circuit further comprises a Darlington transistor circuit configured to multiply the current available from the zener circuit to control the first transistor based on the detected electrostatic discharge.

10. The protection circuit of claim 1, wherein the first pnp hetero-junction bipolar transistor has dissimilar emitter and base materials, wherein
if the base comprises silicon-germanium (Si—Ge), the emitter comprises silicon (Si); and
if the base comprises gallium arsenide (GaAs), the emitter comprises aluminum gallium arsenide (AlGaAs), whereby a sufficiently high holding voltage is provided to the transistor to avoid latch-up.

11. The protection circuit of claim 10, wherein the first pnp hetero-junction bipolar transistor comprises a high voltage transistor operable up to about the collector-emitter breakdown voltage when the base is open, and a holding voltage which avoids latch-up during powered-up normal operating conditions.

12. The protection circuit of claim 10, wherein the first pnp hetero-junction bipolar transistor comprises an n-type silicon-germanium epitaxial base layer in a base region of the transistor.

13. The protection circuit of claim 12, further comprising a p-type emitter polysilicon material layer in the emitter region of the transistor overlying the n-type silicon-germanium epitaxial base layer in the base region of the transistor comprising a vertical hetero-junction bipolar transistor configuration.

14. The protection circuit of claim 1, further comprising
a second high voltage pnp transistor connected between the terminals of the semiconductor device, the second transistor configured as a diode to conduct during a negative over-voltage associated with the electrostatic discharge,
wherein the second transistor absorbs energy from the electrostatic discharge by diode clamping the negative over-voltage across the terminals.

15. The protection circuit of claim 1, further comprising
a second pnp hetero-junction bipolar transistor connected between the terminals of the semiconductor device, the second transistor configured as a diode to conduct during a negative over-voltage associated with the electrostatic discharge,
wherein the second transistor absorbs energy from the electrostatic discharge by diode clamping the negative over-voltage across the terminals.

16. An electrostatic discharge protection circuit, comprising:
a first pnp hetero-junction bipolar transistor connected between power supply terminals of a semiconductor device, the first transistor configured to conduct during a positive over-voltage associated with an electrostatic discharge; and
a trigger circuit connected between the power supply terminals and configured to detect the electrostatic discharge and control the first transistor at a control terminal thereof based on the detected electrostatic discharge;
wherein the first transistor absorbs energy from the electrostatic discharge by clamping the positive over-voltage detected across the power supply terminals.

17. The protection circuit of claim 16, wherein the trigger circuit comprises a transient activated resistor-capacitor (RC) circuit comprising a resistor and a capacitor that are series connected, the RC circuit configured to detect the positive over-voltage associated with the electrostatic discharge by producing a voltage drop across the resistor and the control terminal of the first transistor, and causing the first transistor to conduct during the over-voltage based on the detected electrostatic discharge.

18. The protection circuit of claim 17, wherein the trigger circuit further comprises a Darlington transistor circuit configured to multiply the current available from the resistor-capacitor circuit to control the first transistor to conduct based on the detected electrostatic discharge.

19. The protection circuit of claim 18, wherein the Darlington transistor circuit comprises Darlington connected pnp hetero-junction bipolar transistors individually comprising a resistor connected between emitter and base terminals of the Darlington connected transistors, and wherein an output of the Darlington connected transistors is connected to the control terminal of the first transistor, and an input of the Darlington connected transistors is connected to a capacitor of the transient activated resistor-capacitor (RC) circuit.

20. The protection circuit of claim 16, wherein the trigger circuit comprises a DC voltage activated zener circuit configured to detect a current increase to a zener diode during the electrostatic discharge and to control the first transistor based on the current increase.

21. The protection circuit of claim 20, wherein the trigger circuit further comprises a Darlington transistor circuit configured to multiply the current available from the zener circuit to control the first transistor based on the detected electrostatic discharge.

22. The protection circuit of claim 16, wherein the first pnp hetero-junction bipolar transistor has dissimilar emitter and base materials, wherein
if the base comprises silicon-germanium (Si—Ge), the emitter comprises silicon (Si); and
if the base comprises gallium arsenide (GaAs), the emitter comprises aluminum gallium arsenide (AlGaAs), whereby a sufficiently high holding voltage is provided to the transistor to avoid latch-up.

23. The protection circuit of claim 22, wherein the first pnp hetero-junction bipolar transistor comprises a high voltage transistor having a holding voltage up to about the collector-emitter breakdown voltage when the base is open.

24. The protection circuit of claim 22, wherein the first pnp hetero-junction bipolar transistor comprises an n-type silicon-germanium epitaxial base layer in a base region of the transistor and a p-type emitter polysilicon material layer in the emitter region of the transistor overlying the n-type silicon-germanium epitaxial base layer in the base region of the transistor comprising a vertical hetero-junction bipolar transistor configuration.

25. The protection circuit of claim 16, further comprising
a second pnp hetero-junction bipolar transistor connected between the power supply terminals of the semiconductor device, the second transistor configured as a diode to conduct during a negative over-voltage associated with the electrostatic discharge,
wherein the second transistor absorbs energy from the electrostatic discharge by diode clamping the negative over-voltage across the power supply terminals.

26. An electrostatic discharge protection circuit, comprising:
energy absorbing means for dissipating an over-voltage between two terminals of a semiconductor device during an electrostatic discharge;
switching means for switching between the energy absorbing means and one of the two terminals for conducting energy of the over-voltage into the energy absorbing means for limiting the over-voltage during the electrostatic discharge;
triggering means for detecting the electrostatic discharge between the terminals; and
controlling means for controlling the switching means to conduct the energy of the over-voltage into the energy absorbing means based on the detected electrostatic discharge, thereby limiting an amplitude of the electrostatic discharge.

27. The protection circuit of claim 26, wherein the switching means comprises a pnp hetero-junction bipolar transistor having dissimilar emitter and base materials, wherein
if the base comprises silicon-germanium (Si—Ge), the emitter comprises silicon (Si); and
if the base comprises gallium arsenide (GaAs), the emitter comprises aluminum gallium arsenide (AlGaAs), whereby a sufficiently high holding voltage is provided to the transistor to avoid latch-up.

28. The protection circuit of claim 27, wherein the pnp hetero-junction bipolar transistor comprises a high voltage transistor operable up to about the collector-emitter voltage when the base is open, and at a holding voltage which avoids latch-up during powered-up normal operating conditions.
